(19) United States
(12) Patent Application Publication
(10) Pub. No.: US 2023/0255729 A1
(43) Pub. Date: Aug. 17, 2023

(54) ORTHODONTIC DEVICES AND METHODS OF USE

(71) Applicant: Braces on Demand, Inc., Hicksville, NY (US)

(72) Inventors: Colin James Corey, Carlsbad, CA (US); Ammar Ahmed Syed, Unionville (CA); Thomas Patrick Shannon, Byron Center, MI (US)

(21) Appl. No.: 18/100,997

(22) Filed: Jan. 24, 2023

Related U.S. Application Data
(60) Provisional application No. 63/309,362, filed on Feb. 11, 2022.

(51) Int. Cl. A61C 7/14; A61C 7/00; B33Y 80/00; B33Y 50/00

(52) U.S. Cl. CPC A61C 7/146; A61C 7/002; B33Y 80/00; B33Y 50/00

(57) ABSTRACT

In some embodiments, apparatuses and methods are provided herein useful to orthodontic devices. In some embodiments, an orthodontic device comprises a bonding tray, a plurality of support structures, wherein the plurality of support structures are integral to the bonding tray, and a plurality of orthodontic appliances, wherein the plurality of orthodontic appliances are secured to the bonding tray via the support structures and oriented based on a patient's dentition, and wherein the plurality of orthodontic appliances are integral to the bonding tray.

### TECHNICAL FIELD

This invention relates generally to orthodontics and, more specifically, orthodontic devices.

### BACKGROUND

Orthodontic clinicians seek to correct malocclusions by use of many different devices, such as braces, retainers, palate expanders, positioners, etc. Braces, one of the most commonly used appliances, include brackets, archwires, and ligatures. The brackets are affixed to a patient's teeth and the archwire passes through slots in the brackets designed to receive the archwire. The ligatures secure the archwire within the slots. Clinicians can apply the brackets to the patient's teeth directly or indirectly. When a clinician applies brackets to the patient's teeth directly, the clinician manipulates, and secures to the patient's tooth, each bracket individually. When a clinician applies brackets to the patient's teeth indirectly, the clinician places each of the brackets in a bonding tray and secures the brackets to the patient's teeth simultaneously via the bonding tray. While indirect bonding may make the process of securing the brackets to the patient's teeth easier and improve the accuracy of the placement of the brackets, drawbacks exist with traditional indirect bonding techniques. For example, the bonding trays are created independently of the brackets, introducing inefficiencies. Additionally, the clinician must manually place the brackets in the bonding tray. Manual placement of the brackets in the bonding tray can be time consuming, tedious, difficult, and introduce a source of error (e.g., incorrect placement, alignment, and/or order of the brackets in the bonding tray). Accordingly, a need exists for improved indirect bonding techniques and devices.

### BRIEF DESCRIPTION OF THE DRAWINGS

Disclosed herein are embodiments of systems, apparatuses, and methods pertaining to orthodontic devices. This description includes drawings, wherein:

FIG. 1 depicts a patient's dentition 110 and an orthodontic device 100, according to some embodiments;

FIG. 2A depicts an orthodontic device 200, according to some embodiments;

FIG. 2B depicts an orthodontic device 220 including a plurality of alignment structures 230, according to some embodiments;

FIGS. 3A and 3B depict a perspective view and an elevational view, respectively, of an orthodontic device 300 and a base 302, according to some embodiments;

FIG. 4A and 4B depict a top plan view and a perspective view, respectively, of an orthodontic device 400 including a Class II Corrector 406, according to some embodiments;

FIG. 5 is a flow chart depicting example operations for additively manufacturing an orthodontic device, according to some embodiments;

FIG. 6 is a block diagram of a system 700 for additively manufacturing orthodontic devices, according to some embodiments;

FIG. 7 is a block diagram of a system 800 that may be used for implementing any of the components, circuits, circuitry, systems, functionality, apparatuses, processes, or devices of the system 700 of FIG. 7, and/or other above or below mentioned systems or devices, or parts of such circuits, circuitry, functionality, systems, apparatuses, processes, or devices, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

Generally speaking, pursuant to various embodiments, systems, apparatuses, and methods are provided herein useful to orthodontic devices. In some embodiments, an orthodontic device comprises a bonding tray, a plurality of support structures, wherein the plurality of support structures are integral to the bonding tray, and a plurality of orthodontic appliances, wherein the plurality of orthodontic appliances are secured to the bonding tray via the support structures and oriented based on a patient's dentition, and wherein the plurality of orthodontic appliances are integral to the bonding tray.

As previously discussed, clinicians can apply orthodontic appliances to a patient's teeth directly or indirectly. While indirect bonding may make the process of securing the brackets to the patient's teeth easier and improve the accuracy of the placement of the brackets, drawbacks exist with traditional indirect bonding techniques. For example, the bonding trays are created independently of the brackets, introducing inefficiencies. Additionally, the clinician must manually place the brackets in the bonding tray. Manual placement of the brackets in the bonding tray can be time consuming, tedious, difficult, and introduce a source of error (e.g., incorrect placement, alignment, and/or order of the brackets in the bonding tray). Accordingly, a need exists for improved indirect bonding techniques and devices. Described herein are systems, methods, and apparatuses that seek to minimize, if not eliminate, these drawbacks.

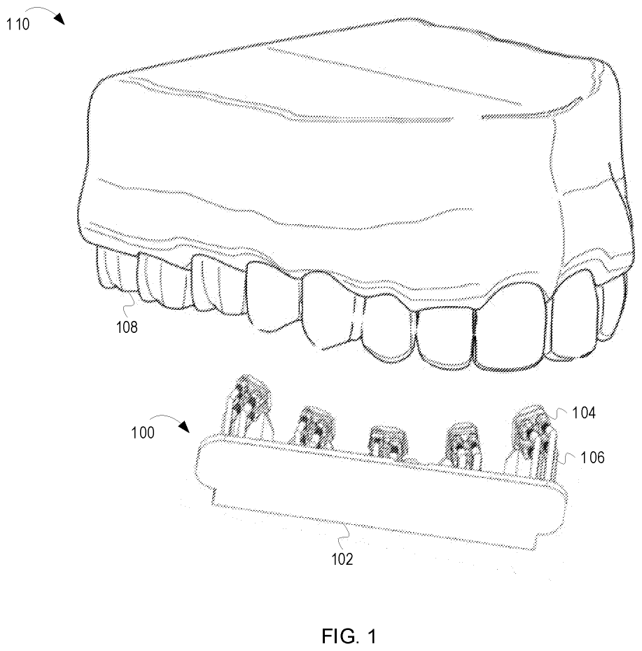

In one embodiment, an orthodontic device comprises a bonding tray, a plurality of support structures, and a plurality of orthodontic appliances. The plurality of support structures are integral to the bonding tray. The plurality of orthodontic appliances are secured to the bonding tray via the plurality of support structures and oriented based on the patient's dentition. The plurality of orthodontic appliances are integral to the bonding tray. In one embodiment, the orthodontic device is manufactured as a single structure. Such an orthodontic device can eliminate the need for a clinician to manually place the orthodontic appliances in a bonding tray. Further, because the orthodontic appliances are secured to the bonding tray and oriented based on the patient's dentition, the possibility of error is reduced. The discussion of FIG. 1 provides an overview of such an orthodontic device.

FIG. 1 depicts a patient's dentition 110 and an orthodontic device 100, according to some embodiments. The orthodontic device 100 includes orthodontic appliances 104, support structures 106, and a bonding tray 102. The support structures 106 secure the orthodontic appliances 104 to the bonding tray 102. In one embodiment, the support structures 106 and the orthodontic appliances 104 are integral to the bonding tray 102. For example, the support structures 106, the orthodontic appliances 104, and the bonding tray 102 can form a single structure. In such embodiments, the orthodontic device 100 (i.e., the support structures 106, the orthodontic appliances 104, and the bonding tray 102) can be manufactured as a single structure.

The support structures 106 are arranged in groups. Each of the groups of support structures 106 is associated with one of the orthodontic appliances 104. That is, each group of support structures 106 secures one of the orthodontic appliances 104 to the bonding tray.

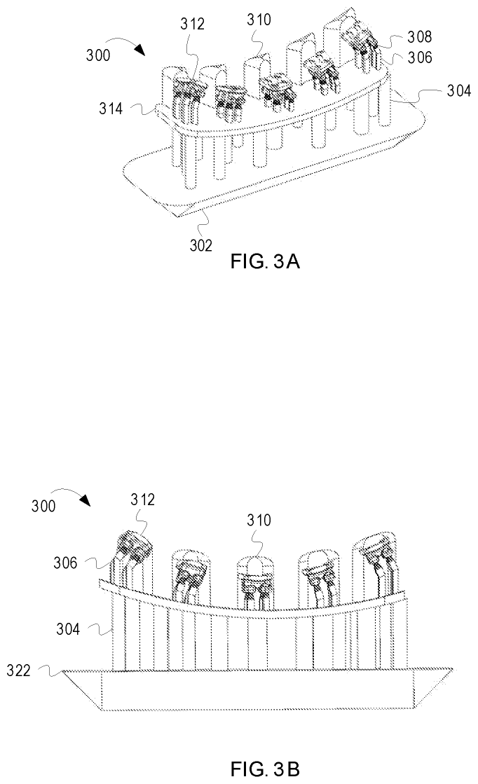

A clinician can use the orthodontic device 100 to indirectly bond (i.e., secure) the orthodontic appliances 104 to teeth 108 in the patient's mouth. In some embodiments, the orthodontic appliances 104 are oriented and/or located such that the orthodontic device 100 correctly locates the orthodontic appliances 104 on the teeth 108 in the patient's mouth. For example, in some embodiments, bonding surfaces of the orthodontic appliances 104 can be based on the curvature of the patient's teeth 108 (e.g., a compound curvature based on a scan of the patient's mouth). In such embodiments, because the bonding surfaces of the orthodontic appliances 104 matches the geometry of the facial (or lingual) surfaces of the patient's teeth 108, the orthodontic device 100 may only be capable of being inserted in the patient's mouth in a single orientation, making it easier for a clinician to quickly and easily locate the orthodontic appliances 104 on the patient's teeth 108. Additionally, or alternatively, such orientation and/or location of the orthodontic appliances 104 can be achieved based on the shape of the bonding tray 102 and/or the geometries of the support structures 106. For example, as depicted in FIG. 1, the shape of the bonding tray is generally planar (i.e., flat) and the support structures 106 have geometries such that bonding surfaces of the orthodontic appliances are properly oriented and/or located on the teeth 108 in the patient's mouth. Alternatively, the bonding tray 102 can have a generally curved shape (e.g., as depicted in FIGS. 3A and 3B) to achieve such proper orientation and/or location on the teeth 108 in the patient's mouth. Additionally, while generally planar and generally curved bonding trays are described herein, embodiments are not so limited. For example, in one embodiment, the bonding tray can be shaped as a negative of the patient's mouth or a portion of the patient's mouth. In such embodiments, the bonding tray can include one or more cavities. Each of the one or more cavities is configured to mate with one or more of the patient's teeth to aid in correctly locating the orthodontic appliances 104 on the patient's teeth.

While the orthodontic device 100 depicted in FIG. 1 includes five orthodontic appliances 104, embodiments are not so limited. For example, the orthodontic device 100 can include greater, or fewer, than five orthodontic appliances 104. For example, the orthodontic device 100 can include only a single orthodontic appliance 104 (e.g., a single bracket, a Class II Corrector, etc.), sufficient orthodontic appliances 104 for a section of a patient's mouth (e.g., a single jaw, a portion of a jaw, etc.), sufficient orthodontic appliances 104 for the entirety of the patient's mouth, etc.

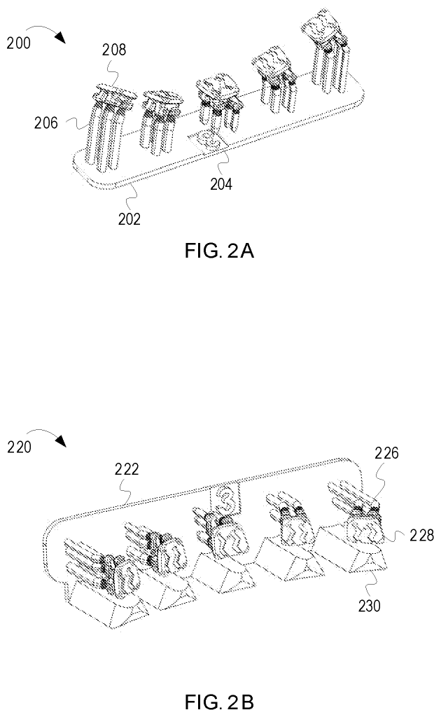

While the discussion of FIG. 1 provides an overview of an orthodontic device including a bonding tray, a plurality of support structures, and a plurality of orthodontic appliances, the discussion of FIGS. 2A-2B provides additional detail regarding such orthodontic devices.

FIG. 2A depicts an orthodontic device 200, according to some embodiments. The orthodontic device 200 includes a bonding tray 202, a plurality of support structures 206, and a plurality of orthodontic appliances 208. The plurality of support structures 206 secure the orthodontic appliances 208 to the bonding tray 202. In one embodiment, the plurality of support structures 206 are arranged in groups. In such embodiments, each group of support structures 206 secures one of the orthodontic appliances 208 to the bonding tray 202. In one embodiment, the orthodontic appliance is manufactured as a single unit.

As depicted in FIG. 2A, the bonding tray 202 is generally planar. The orthodontic appliances 208, however, are angled relative to the bonding tray 202. For example, the orthodontic appliances 208 can be angled such that they are properly oriented to be bonded to teeth in a patient's mouth. The orthodontic appliances 208 can be angled based on the patient's dentition. For example, a scan, or model, of the patient's dentition can be used to determine the angle of the orthodontic appliances 208, and thus the geometries of the support structures 206.

In some embodiments, the orthodontic device 200 can include markings 204. The markings can be included in any suitable location and indicate any desired information. As one example, and as depicted in FIG. 2A, the marking 204 is located on the bonding tray 202. As described in more detail in U.S. patent application Ser. No. 17/011,071 titled SYSTEMS AND METHODS FOR MARKING ORTHODONTIC DEVICES filed Sep. 3, 2020 and incorporated by reference herein in its entirety, the marking 204 can indicate the orthodontic appliances 208 included on the orthodontic device 200, identify a patient with which the orthodontic device 200 is associated, indicate a prescription of the orthodontic device 200, indicate a manufacture date of the orthodontic device 200, include a serial number associated with the orthodontic device 200 and/or the orthodontic appliances 208, etc.

FIG. 2B depicts an orthodontic device 220 including a plurality of alignment structures 230, according to some embodiments. The orthodontic device 220 includes a bonding tray 222, a plurality of support structures 226, and a plurality of orthodontic devices 228. The orthodontic appliances 228 are secured to the bonding tray 222 via the support structures 226. In one embodiment, the support structures 226 are arranged into groups. In such embodiments, each group of support structures 226 can secure one, or multiple, orthodontic appliances 228 to the bonding tray 222.

Additionally, as shown in the example depicted in FIG. 2B, the orthodontic device 220 includes alignment structures 230. In some embodiments, the alignment structures 230 are integral to the orthodontic device 220. For example, as depicted in FIG. 2B, the alignment structures 230 are integral to the bonding tray 222. Though the alignment structures 230 are shown as being integral to the bonding tray 222 in FIG. 2B, such is not required. For example, the alignment structures 222 can be separate from the orthodontic device 220, integral with the support structures 226, integral with the orthodontic appliances 228, integral with a base of the orthodontic device 220 (e.g., with the base depicted in FIGS. 3A and 3B), etc. The alignment structures 230 can have geometries suitable for aiding the placement of the orthodontic appliances 228 on the patient's teeth. For example, the alignment structures 230 can be designed such that they rest on one or more surfaces of the patient's teeth (e.g., facial surfaces, chewing surfaces, etc.). In some embodiments, the alignment structures 230 are shaped such that they match the geometry of one or more of the teeth in the patient's mouth. For example, a surface of the alignment structures can be formed to match a chewing surface of one or more of the patient's teeth, a facial surface of one or more of the patient's teeth, etc. Accordingly, the geometries of the alignment structures 230 can be based on a scan, or model, of the patient's dentition.

While the discussion of FIGS. 2A and 2B provides additional detail regarding an orthodontic device, the discussion of FIGS. 3A and 3B provide additional detail regarding an orthodontic device including a base.

FIGS. 3A and 3B depict a perspective view and an elevational view, respectively, of an orthodontic device 300 and a base 302, according to some embodiments. The orthodontic device 300 includes a bonding tray 314, first support structures 306, and orthodontic appliances 312. The orthodontic appliances 312 are secured to the bonding tray 314 via the first support structures 306. As depicted in FIGS. 3A and 3B, the first support structures 306 are arranged in groups. Each group of the first support structures 306 secures one of the orthodontic appliances 312 to the bonding tray 314.

The orthodontic device 300 is positioned on the base 302. The orthodontic device 300 is supported on the base 302 by second support structures 304. In one embodiment, the base 302 is integral to the orthodontic device 300. For example, the orthodontic device 300 and the base 302 can be manufactured together as a single structure.

In some embodiments, the orthodontic devices 312 are designed to be easily severable from the first support structures 306. For example, the first support structures 306 can join the orthodontic appliances 312 at a joint 308. In such embodiments, and as described in more detail in U.S. patent application Ser. No. 16/875,618 titled SYSTEMS AND METHODS FO MANUFACTURE OF ORTHODONTIC APPLIANCES filed May 15, 2020 and U.S. patent application Ser. No. 17/011,121 titled SYSTEMS AND METHODS FOR MANUFACTURING ORTHODONTIC DEVICES filed Sep. 3, 2020, both incorporated by reference herein in their entirety, the first support structures 306 can be configured to fracture at the joint 308 so that the orthodontic appliances 312 can be removed from the orthodontic device 300. The orthodontic appliances 312 can be separated from the first support structures 306 by physically breaking the joint, severing the joint with an instrument such as a knife or scissors, etc. In one embodiment, the joint 308 has a double taper configuration. In the double taper configuration, both ends of the joint 308 taper to a section that is, for example, thinner than the rest of the first support structures 306 or otherwise includes less material than the rest of the first support structures 306. The thinning of the first support structures 306 at the joint 308 allows the orthodontic appliances 312 to be detached from the orthodontic device 300 by a user via physical input. The geometry of the joint 308 focuses stress from physical manipulation of the orthodontic appliances, bonding tray 302, and/or base 302 at a desired location within the joint 308. Accordingly, such joint 308 geometry allows for a clean fracture of the material at, or near, the joint 308. Additionally, in some embodiments, the second support structures 304 can meet the bonding tray 314 at a joint similar to that of the first support structures to allow easy severability of the orthodontic device 300 from the base 302.

The example orthodontic device 300 depicted in FIGS. 3A and 3B includes a curved bonding tray 314. In some embodiments, the bonding tray 314 can feature a curved geometry such that it more closely matches the general curvature of a patient's dentition or a portion of the patient's dentition with which the orthodontic appliances 312 are associated. For example, if the orthodontic appliances 312 are to be installed in the front of a patient's mouth, the geometry of the bonding tray 314 will feature a greater curvature than if the orthodontic appliances 312 are to be installed on the side of a patient's mouth. Further, in some embodiments, the bonding tray 314 can be curved to match a specific patient's dentition. In such embodiments, the curvature of the bonding tray 314 can be based on a scan, or model, of the patient's dentition. In some embodiments, some, or all, of the orthodontic appliances 312 can be angled with respect to the bonding tray 314.

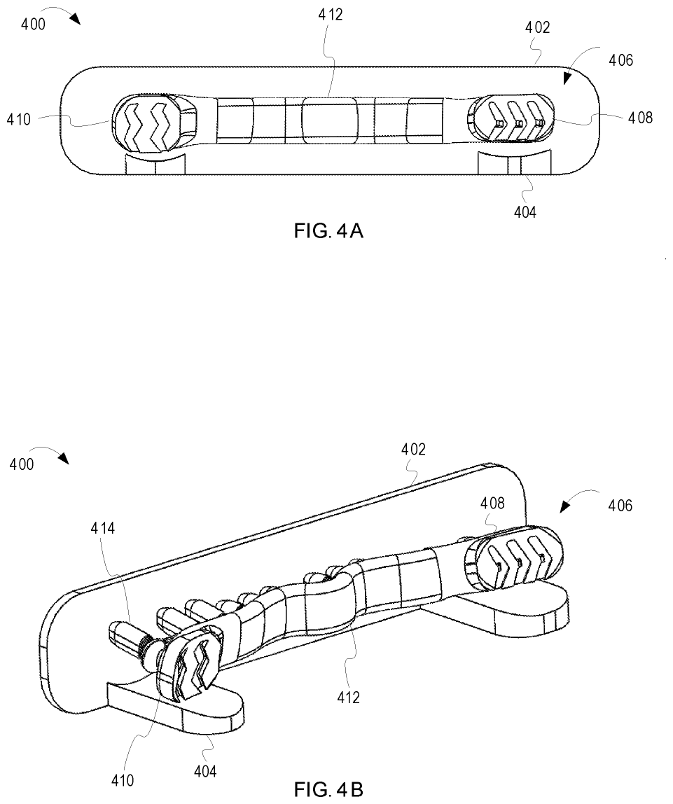

While FIGS. 1-3 depict an orthodontic device including multiple orthodontic appliances, FIG. 4 depicts an orthodontic device including a single orthodontic appliance.

FIG. 4A and 4B depict a top plan view and a perspective view, respectively, of an orthodontic device 400 including a Class II Corrector 406, according to some embodiments. The orthodontic device 400 includes a bonding tray 402, a plurality of support structures 414, and the Class II Corrector 406 (i.e., an orthodontic appliance). The plurality of support structures 414 secure the orthodontic appliance 406 to the bonding tray 402.

Though the orthodontic appliance depicted in FIGS. 4A and 4B is a Class II Corrector, embodiments are not so limited. That is, the Class II Corrector 408 depicted in FIGS. 4A and 4B can be replaced with any suitable orthodontic appliance.

The Class II Corrector 406 can be of any suitable type. For example, as depicted in FIGS. 4A and 4B, the Class II Corrector 406 is a single structure. However, it should be noted that such is not required. For example, the Class II Corrector 406 can be a single orthodontic appliance that is a composite of multiple, smaller orthodontic devices, as described in U.S. patent application Ser. No. 17/233,116 titled ORTHODONTIC DEVICES filed Apr. 16, 2021 and incorporated by reference herein in its entirety. The Class II Corrector includes a first portion 410 and a second portion 408 (also referred to as “orthodontic devices”). Each of the first portion 410 and the second portion 408 are configured to be secured to a tooth in a patient's mouth. The first portion 410 and the second portion 408 are connected via a main body portion 412.

Additionally, as shown in the example depicted in FIGS. 4A and 4B, the orthodontic device 400 includes alignment structures 404. In some embodiments, the alignment structures 404 are integral to the orthodontic device 400. For example, as depicted in FIGS. 4A and 4B, the alignment structures 404 are integral to the bonding tray 402. Though the alignment structures 404 are shown as being integral to the bonding tray 402 in FIGS. 4A and 4B, such is not required. For example, the alignment structures 404 can be separate from the orthodontic device 400, integral with the support structures 414, integral with the orthodontic appliance 406, integral with a base of the orthodontic device 400 (e.g., with the base depicted in FIGS. 3A and 3B), etc. The alignment structures 404 can have geometries suitable for aiding the placement of the orthodontic appliance 406 on the patient's teeth. For example, the alignment structures 404 can be designed such that they rest on one or more surfaces of the patient's teeth (e.g., facial surfaces, chewing surfaces, etc.). Accordingly, the geometries of the alignment structures 404 can be based on a scan, or model, of the patient's dentition.

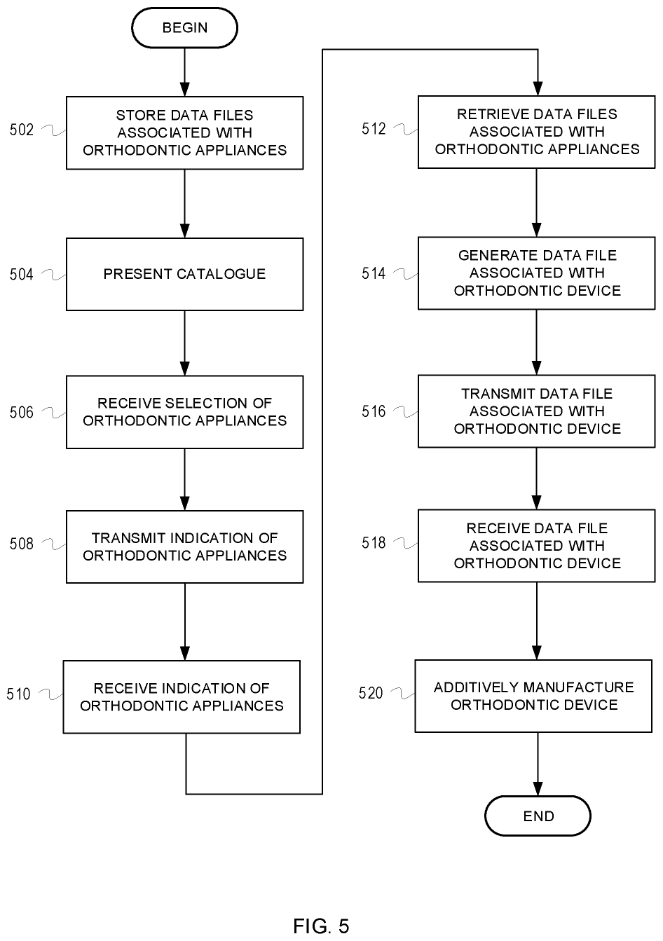

While the discussion of FIGS. 1-4 provide additional detail regarding orthodontic devices including a bonding tray, support structures, and orthodontic appliances, the discussion of FIGS. 5-7 provide additional detail regarding the manufacture of such orthodontic devices.

FIG. 5 is a flow chart depicting example operations for additively manufacturing an orthodontic device, according to some embodiments. The flow begins at block 502.

At block 502, data files associated with orthodontic appliances are stored. For example, a database can store the data files. The data files are associated with orthodontic appliances such that the data files can be used to manufacture or otherwise produce orthodontic appliances based on the data files. In one embodiment, the data files are CAD files. The data files can be generated before, or at the time of, retrieval. The database can be of any suitable type and store the data files in any suitable manner. For example, the database can be a relational database, a NoSQL database, etc. The database stores the data files after they are generated. The flow continues at block 504.

At block 504, a catalogue is presented. For example, a user device can present the catalogue to a user. The catalogue includes orthodontic appliances that the user can purchase or otherwise obtain. The user can browse the catalogue and make selections via the user device. The flow continues at block 506.

At block 506, a selection of orthodontic appliances is received. For example, the user device can receive a selection of one or more orthodontic appliances. The selection of the orthodontic appliance can indicate which orthodontic appliance the user would like to manufacture and/or include in an orthodontic device. In some embodiments, can also indicate modifications to the orthodontic appliance. For example, the catalogue can include a number of base orthodontic appliances. At least some of the base orthodontic appliances are modifiable by the user. The user selection can include an indication of the modifications. The flow continues at block 508.

At block 508, an indication of orthodontic appliances is transmitted. For example, the user device can transmit an indication of the orthodontic appliances via a network. The indication of the orthodontic appliances indicates which orthodontic appliances the user has chosen as well as any modifications to the orthodontic appliances. Additionally, the indication of the orthodontic appliances can include detail regarding sequencing of the orthodontic appliances on the orthodontic device, orientations of the orthodontic appliances with respect to the orthodontic device, etc. The flow continues at block 510.

At block 510, the indication of the orthodontic appliances is received. For example, a control circuit can receive the indications of the orthodontic appliances. The flow continues at block 512.

At block 512, data files are retrieved. For example, the control circuit can retrieve the data files from the database. The data files are associated with the orthodontic appliances. That is, the data files include the instructions and/or parameters necessary to manufacture the orthodontic appliances that the user has selected. In some embodiments, the control circuit can encrypt or otherwise protect the data files. As one example, the control circuit can encode the data file with single use encryption. The flow continues at block 514.

At block 514, a data file is generated. For example, the control circuit can generate the data file. The data file is associated with an orthodontic device. The orthodontic device includes the orthodontic appliances selected by the user, a bonding tray, and support structures. The control circuit generates the data file based on the data files associated with the orthodontic appliances selected by the user and data associated with a patient's mouth. The data associated with the patient's mouth can include measurements of the patient's dentition, scans of the patient's mouth, models of the patient's mouth, a prescription associated with the patient's mouth, etc. The data file associated with the orthodontic device includes the data necessary to additively manufacture the orthodontic device. That is, the data file associated with the orthodontic device includes the data necessary to additively manufacture the bonding tray, the support structures, and the orthodontic appliances. The flow continues at block 516.

At block 516, the data file associated with the orthodontic device is transmitted. For example, the control circuit can transmit the data file associated with the orthodontic device. The control circuit can transmit the data file associated with the orthodontic device to the user device and/or a manufacturing device. In some embodiments, the control circuit can encrypt or otherwise protect the data file associated with the orthodontic device. As one example, the control circuit can encode the data file associated with the orthodontic device with single use encryption. The flow continues at block 518.

At block 518, the data file associated with the orthodontic device is received. For example, the data file associated with the orthodontic device can be received by the user device and/or the manufacturing device. If the data file associated with the orthodontic device is received by the user device, the user device transmits the data file associated with the orthodontic device to the manufacturing device. The flow continues at block 520.

At block 520, the orthodontic device is manufactured. For example, the manufacturing device can manufacture the orthodontic device. The manufacturing device manufactures the orthodontic device based on the data file associated with the orthodontic device. The manufacturing device can be of any type suitable to additively manufacture the orthodontic device. For example, the manufacturing device can be a 3D printer or other additive manufacturing device.

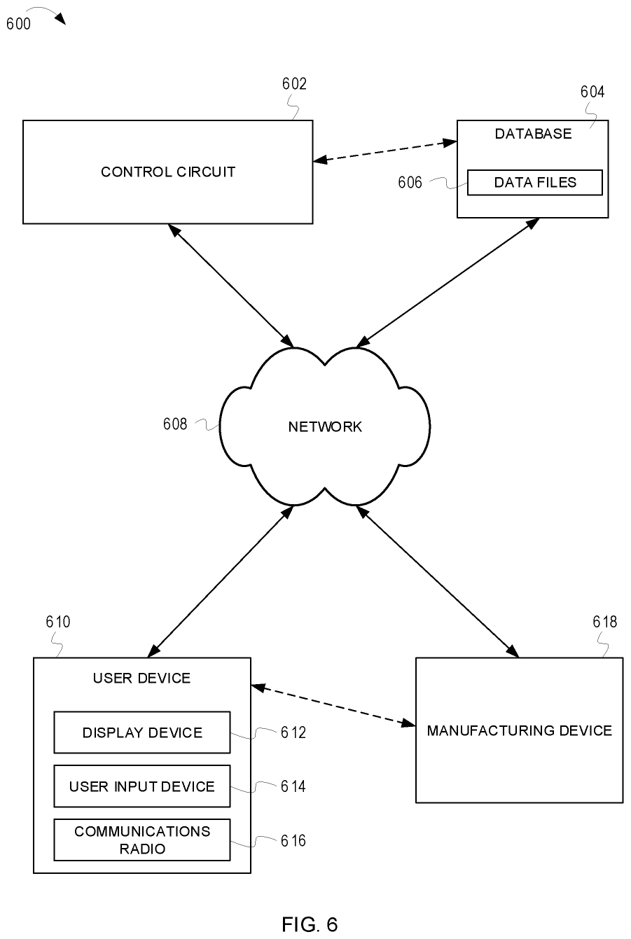

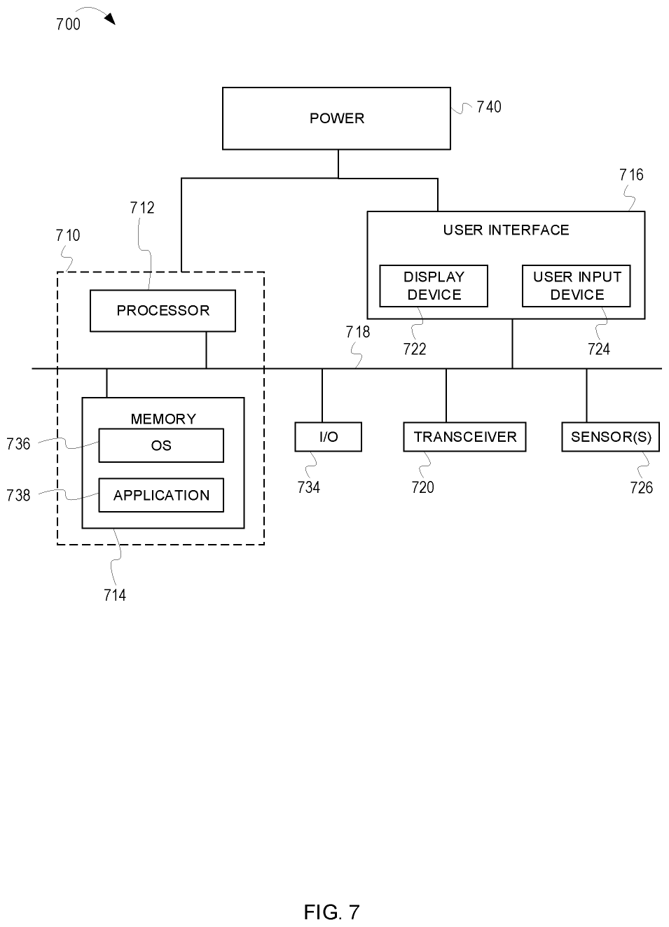

While the discussion of FIG. 5 describes example operations for manufacturing an orthodontic device, the discussion of FIGS. 6 and 7 provide additional detail regarding system for manufacturing orthodontic devices.

FIG. 6 is a block diagram of a system 600 for additively manufacturing orthodontic devices, according to some embodiments. The system 600 includes a control circuit 602, a database 604, a user device 610, and a manufacturing device 618. One or more of the control circuit 602, the database 604, the user device 610, and the manufacturing device 618 are communicatively coupled via a network 608. The network 608 can include a local area network (LAN) and/or wide area network (WAN), such as the internet. Accordingly, the network 608 can include wired and/or wireless links.

The user device 610 can be any suitable type of computing device (e.g., a desktop or laptop computer, smartphone, tablet, etc.). The user device 610 includes a display device 612. The display device 612 is configured to present a catalogue to a user. The catalogue includes orthodontic appliances that the user can obtain via the system 600. For example, the catalogue can include all orthodontic devices that the user can purchase and/or manufacture via the manufacturing device 618. The user interacts with the catalogue via a user input device 614. The user can interact with the catalogue by navigating the catalogue, making selections from the catalogue, modifying orthodontic appliances included in the catalogue, etc. Accordingly, the user input device 614 can be of any suitable type, such as a mouse, keyboard, trackpad, touchscreen, etc. The user device 610 also includes a communications radio 616. The communications radio 616 transmits and receives information for the user device 610. For example, in the case of a smartphone, the communications radio 616 can be a cellular radio operating in accordance with the 4G LTE standard. Once a user has made a selection of an orthodontic appliance, the user device 610, via the communications radio 616 and the network 708, transmits an indication of the selection to the control circuit 602.

The control circuit 602 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 602 is configured (for example, by using corresponding programming as will be well understood by those skilled in the art) to carry out one or more of the steps, actions, and/or functions described herein.

By one optional approach the control circuit 602 operably couples to a memory. The memory may be integral to the control circuit 602 or can be physically discrete (in whole or in part) from the control circuit 602 as desired. This memory can also be local with respect to the control circuit 602 (where, for example, both share a common circuit board, chassis, power supply, and/or housing) or can be partially or wholly remote with respect to the control circuit 602 (where, for example, the memory is physically located in another facility, metropolitan area, or even country as compared to the control circuit 602).

This memory can serve, for example, to non-transitorily store the computer instructions that, when executed by the control circuit 602, cause the control circuit 602 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit may be remote from the user device 610 and/or the manufacturing device 618. For example, the user device 610 and the manufacturing device 618 may be located in a clinician's office (e.g., the user's office) whereas the control circuit 702, and possibly the database 604, are cloud-based. The control circuit 602 generally operates to retrieve data files 606 based on the user's selection of orthodontic appliances. The control circuit 602 retrieves the data files 606 from the database 604. The database 604 is configured to store the data files 606. The data files 606 are associated with orthodontic appliances. The data files 606 are CAD files from which the orthodontic devices can be manufactured. The database 604 stores a data file for each of the orthodontic appliances included in the catalogue. In one embodiment, the database 604 stores a data file for all possible permutations of each orthodontic appliance (e.g., every possible modification and/or combination or modifications for each orthodontic appliance). The control circuit 602 receives the indication of the orthodontic appliance and retrieves a data file based on the indication of the orthodontic appliance.

It should be noted that the indication of the orthodontic appliance may include more than one orthodontic appliance. For example, the indication of the orthodontic appliance can include multiple orthodontic appliances, such as full set of brackets for a patient. Accordingly, the data file can be a file including instructions and/or specifications for multiple orthodontic appliances. For example, the data file may include multiple data files and/or multiple specifications for a number of brackets.

In some embodiments, the control circuit 602 generates a data file associated with an orthodontic device. The orthodontic device includes a bonding tray, orthodontic appliances, and support structures. The support structures secure the orthodontic appliances to the bonding tray. The data file associated with the orthodontic device includes the data necessary to manufacture the orthodontic device. The control circuit 602 generates the data file associated with the orthodontic device based on the orthodontic appliances selected from the catalogue and data associated with the patient's mouth. The data associated with the patient's mouth can include measurements of the patient's dentition, scans of the patient's mouth, models of the patient's mouth, a prescription associated with the patient's mouth, etc. In some embodiments, the control circuit 602 can make selections for the orthodontic device based on the selected orthodontic appliances and/or the data associated with the patient's mouth. For example, the control circuit can select (or otherwise generate) a planar or curved bonding tray, the curvature of the bonding tray, the dimensions of the bonding tray, the orientations of the orthodontic appliances with respect to one another and/or the bonding tray, the locations of the orthodontic appliances with respect to one another and/or the bonding tray, markers associated with the orthodontic device and/or orthodontic appliances, etc.

After generating the data file associated with the orthodontic device, the control circuit 602 transmits the data file associated with the orthodontic device. In some embodiments, the control circuit 602 encrypts or otherwise protects the data file associated with the orthodontic device before transmission. The control circuit 602 can encrypt or otherwise protect the data file associated with the orthodontic device before transmission to prevent those other than the user from accessing the data file. Additionally, in some embodiments, the control circuit 602 can encrypt or otherwise protect the data file associated with the orthodontic device to control the user's access to the data file associated with the orthodontic device. For example, in some embodiments, the system is set up such that users pay on a per manufacture or per print basis. That is, the user does not purchase, and may not later have access to, the data files associated with the orthodontic appliances and/or the data file associated with the orthodontic device. Rather, the user purchases access to print or otherwise manufacture an orthodontic device based on the data file associated with the orthodontic device once (or another specified number of times).

Dependent upon the embodiment, the control circuit 602 transmits the data file associated with the orthodontic device to the user device 610, the manufacturing device 618, or a third-party device (e.g., a laboratory capable of manufacturing the orthodontic appliance for the user). To whom, or to what, device the data file associated with the orthodontic device is transmitted may also aid in achieving access control. For example, in one embodiment, the control circuit 602 transmits the data file associated with the orthodontic device directly to the manufacturing device 618. Because the data file associated with the orthodontic device is not transmitted to the user device 610, the data file associated with the orthodontic device may not be easily accessible by the user device 610. Further, if an entity that controls the control circuit 602 controls the manufacturing device 618, access to files received by the manufacturing device 618 may be further limited. In some embodiments, the control circuit 602 transmits the data file associated with the orthodontic device to the user device 610. In such embodiments, the user device 610 transmits, via the communications radio (e.g., over a universal serial bus (USB) connection, wireless connection based on the 802.11 standard, etc.), the data file associated with the orthodontic device to the manufacturing device 618.

The manufacturing device 618 additively manufacturers the orthodontic device based on the data file. The manufacturing device 618 can be of any suitable type, such as a 3D printer. The manufacturing device 618 can be local to, or remote from, one or more of the control circuit 602 and the user device 610. For example, in one embodiment, the user device 610 and the manufacturing device 618 are located in the user's office (i.e., the user device 710 and the manufacturing device 618 are local to one another). Alternatively, the manufacturing device 618 may be located in a laboratory or some other facility that manufactures orthodontic appliances for the user.

FIG. 7 is a block diagram of a system 700 that may be used for implementing any of the components, circuits, circuitry, systems, functionality, apparatuses, processes, or devices of the system 600 of FIG. 6, and/or other above or below mentioned systems or devices, or parts of such circuits, circuitry, functionality, systems, apparatuses, processes, or devices, according to some embodiments. The circuits, circuitry, systems, devices, processes, methods, techniques, functionality, services, servers, sources and the like described herein may be utilized, implemented and/or run on many different types of devices and/or systems. For example, the system 800 may be used to implement some or all of the control circuit, the database, the user device, the manufacturing device, and/or other such components, circuitry, functionality and/or devices. However, the use of the system 700 or any portion thereof is certainly not required.

By way of example, the system 700 may comprise a processor (e.g., a control circuit) 712, memory 714, and one or more communication links, paths, buses or the like 718. Some embodiments may include one or more user interfaces 716, and/or one or more internal and/or external power sources or supplies 740. The processor 712 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the processor 712 can be part of control circuitry and/or a control system 710, which may be implemented through one or more processors with access to one or more memory 714 that can store commands, instructions, code and the like that is implemented by the control circuit and/or processors to implement intended functionality. In some applications, the control circuit and/or memory may be distributed over a communications network (e.g., LAN, WAN, the Internet) providing distributed and/or redundant processing and functionality. Again, the system 700 may be used to implement one or more of the above or below, or parts of, components, circuits, systems, processes and the like.

In one embodiment, the memory 714 stores data and executable code, such as an operating system 736 and an application 738. The application 738 is configured to be executed by the system 700 (e.g., by the processor 712). The application 738 can be a dedicated application (e.g., an application dedicated to orthodontic appliances, orthodontic devices, the manufacture of orthodontic appliances and/or orthodontic devices, selection of orthodontic appliances, etc.) and/or a general purpose application (e.g., a web browser, a retail application etc.). Additionally, though only a single instance of the application 738 is depicted in FIG. 7, such is not required and the single instance of the application 738 is shown in an effort not to obfuscate the figures. Accordingly, the application 738 is representative of all types of applications resident on the system (e.g., software preinstalled by the manufacturer of the system, software installed by an end user, etc.). In one embodiment, the application 738 operates in concert with the operating system 736 when executed by the processor 712 to cause actions to be performed by the system 700. For example, with respect to the disclosure contained herein, execution of the application 738 by the processor 712 causes the system to perform actions consistent with the selection and/or manufacture of orthodontic appliances and/or orthodontic appliance assemblies as described herein.

The user interface 716 can allow a user to interact with the system 700 and receive information through the system. In some instances, the user interface 716 includes a display device 722 and/or one or more user input device 724, such as buttons, touch screen, track ball, keyboard, mouse, etc., which can be part of or wired or wirelessly coupled with the system 700. Typically, the system 700 further includes one or more communication interfaces, ports, transceivers 720 and the like allowing the system 700 to communicate over a communication bus, a distributed computer and/or communication network (e.g., a local area network (LAN), wide area network (WAN) such as the Internet, etc.), communication link 718, other networks or communication channels with other devices and/or other such communications or combination of two or more of such communication methods. Further the transceiver 720 can be configured for wired, wireless, optical, fiber optical cable, satellite, or other such communication configurations or combinations of two or more of such communications. Some embodiments include one or more input/output (I/O) ports 734 that allow one or more devices to couple with the system 700. The I/O ports can be substantially any relevant port or combinations of ports, such as but not limited to USB, Ethernet, or other such ports. The I/O interface 734 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 726 to provide information to the system and/or sensor information that is communicated to another component, such as the central control system, a delivery vehicle, etc. The sensors 726 can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, imaging system and/or camera, other such sensors or a combination of two or more of such sensor systems. The foregoing examples are intended to be illustrative and are not intended to convey an exhaustive listing of all possible sensors. Instead, it will be understood that these teachings will accommodate sensing any of a wide variety of circumstances in a given application setting.

The system 700 comprises an example of a control and/or processor-based system with processor 712. Again, the processor 712 can be implemented through one or more processors, controllers, central processing units, logic, software and the like. Further, in some implementations the processor 712 may provide multiprocessor functionality.

The memory 714, which can be accessed by the processor 712, typically includes one or more processor-readable and/or computer-readable media accessed by at least the control circuit, and can include volatile and/or nonvolatile media, such as RAM, ROM, EEPROM, flash memory and/or other memory technology. Further, the memory 714 is shown as internal to the control system 710; however, the memory 714 can be internal, external or a combination of internal and external memory. Similarly, some, or all, of the memory 714 can be internal, external or a combination of internal and external memory of the processor 712. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over a computer network. The memory 714 can store code, software, executables, scripts, data, content, lists, programming, programs, log or history data, user information, customer information, product information, and the like. While FIG. 7 illustrates the various components being coupled together via a bus, it is understood that the various components may actually be coupled to the control circuit and/or one or more other components directly.

In some embodiments, an orthodontic device comprises a bonding tray, a plurality of support structures, wherein the plurality of support structures are integral to the bonding tray, and a plurality of orthodontic appliances, wherein the plurality of orthodontic appliances are secured to the bonding tray via the support structures and oriented based on a patient's dentition, and wherein the plurality of orthodontic appliances are integral to the bonding tray.

In some embodiments, an orthodontic device comprises a bonding tray, a plurality of orthodontic appliances, and a plurality of support structurers, wherein the plurality of support structures includes groups of support structures, wherein each group of support structures connects one of the plurality of orthodontic appliances to the bonding tray at an orientation based on a patient's dentition, wherein the orthodontic device is defined by a computer data file, wherein the computer data file includes data to additively manufacture the orthodontic device includes the bonding tray, the plurality of orthodontic appliances, and the plurality of support structures.

In some embodiments, a system for additively manufacturing an orthodontic appliance comprises a database storing data files associated with orthodontic appliances, a user device, wherein the user device includes a display device, wherein the display device is configured to present, to a user, a catalogue, wherein the catalogue includes the orthodontic appliances, a user input device, wherein the user input device is configured to receive, from the user, a selection of a plurality of the orthodontic appliances, and a communications radio, wherein the communications radio is configured to transmit, via a network, an indication of the plurality of orthodontic appliances and data associated with a patient's mouth, a control circuit, wherein the control circuit is configured to receive, via the network from the user device, the indication of the plurality of orthodontic appliances and the data associated with the patient's mouth, retrieve, from the database, ones of the data files associated with the plurality of orthodontic appliances, wherein the ones of the data files associated with the plurality of orthodontic appliances correspond to the indication of the ones of the plurality of orthodontic appliances, generate based on the ones of the data files associated with the plurality of orthodontic appliances and the data associated with the patient's mouth, a data file associated with the orthodontic device, wherein the orthodontic device comprises a bonding tray, a plurality of support structures, and the plurality of orthodontic appliances, and wherein the data file associated with the orthodontic device includes data to additively manufacture the bonding tray, the support structures, and the plurality of orthodontic appliances, and transmit, via the network to a manufacturing device, the data file associated with the orthodontic device, and the manufacturing device, wherein the manufacturing device is configured to receive, via the network from the control circuit, the data file associated with the orthodontic device, and additively manufacture, based on the data file associated with the orthodontic device, the orthodontic device.

In some embodiments, an apparatus and a corresponding method performed by the apparatus comprises receiving, by a control circuit from a user device, an indication of a plurality of orthodontic appliances and data associated with a patient's mouth, retrieving, by the control circuit from a database, data files associated with the plurality of orthodontic appliances, generating, by the control circuit based on the data files associated with the plurality of orthodontic appliances and the data associated with the patient's mouth, a data file associated with the orthodontic device, wherein the orthodontic device comprises a bonding tray, a plurality of support structures, and the plurality of orthodontic appliances, and wherein the data file associated with the orthodontic device includes data to additively manufacture the bonding tray, the support structures, and the plurality of orthodontic appliances, and transmitting, by the control circuit to a manufacturing device, the data file associated with the orthodontic device.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. An orthodontic device, the orthodontic device comprising:
a bonding tray;
a plurality of support structures, wherein the plurality of support structures are integral to the bonding tray; and
a plurality of orthodontic appliances, wherein the plurality of orthodontic appliances are secured to the bonding tray via the support structures and oriented based on a patient's dentition, and wherein the plurality of orthodontic appliances are integral to the bonding tray.

2. The orthodontic device of claim 1, wherein the orthodontic device is additively manufactured as a single unit.

3. The orthodontic device of claim 2, wherein the orthodontic device is additively manufactured on a base, and wherein the bonding tray is secured to the base via a second plurality of support structures.

4. (canceled)

5. The orthodontic device of claim 1, wherein a shape of the bonding tray is based on the patient's dentition.

6. The orthodontic device of claim 5, wherein the shape of the bonding tray is based on a scan of the patient's dentition.

7. The orthodontic device of claim 1, wherein at least some of the plurality of orthodontic appliances are angled relative to the bonding tray.

8. (canceled)

9. The orthodontic device of claim 1, wherein the plurality of orthodontic appliances include one or more of brackets, molar tubes, buccal tubes, Class II correctors, Class III correctors, and auxiliaries.

10. An orthodontic device, the orthodontic device comprising:
a bonding tray;
a plurality of orthodontic appliances; and
a plurality of support structures, wherein the plurality of support structures includes groups of support structures, wherein each group of support structures connects one of the plurality of orthodontic appliances to the bonding tray at an orientation based on a patient's dentition;
wherein the orthodontic device is defined by a computer data file, wherein computer data file includes data to additively manufacture the orthodontic device including the bonding tray, the plurality of orthodontic appliances, and the plurality of support structures.

11. The orthodontic device of claim 10, wherein the bonding tray, the plurality of orthodontic appliances, and the plurality of support structures are additively manufactures as a single unit.

12. The orthodontic device of claim 11, wherein the orthodontic device is additively manufactured on a base, and wherein the bonding tray is secured to the base via a second plurality of support structures.

13. The orthodontic device of claim 10, wherein the plurality of orthodontic appliances are oriented with respect to the bonding tray such that no internal supports are necessary for the plurality of orthodontic appliances.

14. The orthodontic device of claim 10, wherein a shape of the bonding tray is based on the patient's dentition.

15. The orthodontic device of claim 14, wherein the shape of the bonding tray is based on a scan of the patient's dentition.

16. The orthodontic device of claim 10, wherein at least some of the plurality of orthodontic appliances are angled relative to the bonding tray.

17. (canceled)

18. A system for additively manufacturing an orthodontic device, the system comprising:
a database storing data files associated with orthodontic appliances;
a user device, wherein the user device includes:
a display device, wherein the display device is configured to:
present, to a user, a catalogue, wherein the catalogue includes the orthodontic appliances;
a user input device, wherein the user input device is configured to:
receive, from the user, a selection of a plurality of the orthodontic appliances; and
a communications radio, wherein the communications radio is configured to:
transmit, via a network, an indication of the plurality of the orthodontic appliances and data associated with a patient's mouth;
a control circuit, wherein the control circuit is configured to:
receive, via the network from the user device, the indication of the plurality of the orthodontic appliances and the data associated with the patient's mouth;
retrieve, from the database, ones of the data files associated with the plurality of orthodontic appliances, wherein the ones of the data files associated with the plurality of the orthodontic appliances correspond to the indication of the ones of the plurality of the orthodontic appliances;
generate, based on the ones of the data files associated with the plurality of orthodontic appliances and the data associated with the patient's mouth, a data file associated with the orthodontic device, wherein the orthodontic device comprises a bonding tray, a plurality of support structures, and the plurality of orthodontic appliances, and wherein the data file associated with the orthodontic device includes data to additively manufacture the bonding tray, the support structures, and the plurality of orthodontic appliances; and
transmit, via the network to a manufacturing device, the data file associated with the orthodontic device; and
the manufacturing device, wherein the manufacturing device is configured to:
receive, via the network from the control circuit, the data file associated with the orthodontic device; and
additively manufacture, based on the data file associated with the orthodontic device, the orthodontic device.

19. The system of claim 18, wherein the bonding tray, the support structures, and the plurality of orthodontic appliances are additively manufactured as a single unit.

20. The system of claim 19, wherein the orthodontic device is additively manufactured on a base, and wherein the bonding tray is secured to the base via a second plurality of support structures.

21. The system of claim 18, wherein a shape of the bonding tray is based on the data associated with the patient's mouth.

22. The system of claim 18, wherein the data associated with the patient's mouth is based on a scan of the patient's dentition.

23. The system of claim 18, wherein at least some of the plurality of orthodontic appliances are angled relative to the bonding tray.

24.-35. (canceled)
